(19) United States
(12) Patent Application Publication
(10) Pub. No.: US 2002/0003781 A1
(43) Pub. Date: Jan. 10, 2002

(54) Readily reconfigurable data relay device and multiplex communication system

(76) Inventors: Hajime Kikkawa, Nagoya-city (JP); Tomohisa Kishigami, Obu-city (JP); Jiro Sato, Kariya-city (JP); Shinichi- Senoo, Kariya-city (JP)

Correspondence Address: LAW OFFICE OF DAVID G POSZ, 2000 L STREET, N.W., SUITE 200, WASHINGTON, DC, 20036, US

(21) Appl. No.: 09/877,029

(22) Filed: Jun. 11, 2001

(30) Foreign Application Priority Data
Jul. 6, 2000 (JP) 2000-205101

(51) Int. Cl. H04L 12/28

(52) U.S. Cl. 370/254; 370/257; 370/389

(57) ABSTRACT

A multiplex communication system includes a data relay unit which has a plurality of send/receive (SR) sections. Communication lines are connected to the respective SR sections, and nodes are connected to the communication lines. The data relay unit further includes a destination table and header tables. In the data relay unit, a data frame sent from a node is received by one of the SR sections, and the SR sections which ought to send the data frame are identified by referring to the destination table. A header according to the appropriate communication protocol is formed by referring to one of the header tables. Further the data frame including the formed header is formed and sent to the destination node by the identified SR sections. When nodes are added or eliminated, this system can be reconfigured only by modifying or replacing the destination table and the header tables.

### CROSS REFERENCE TO RELATED APPLICATION

The present invention relates to and incorporates herein by reference Japanese Patent Application No. 2000-205101 filed on Jul. 6, 2000.

### BACKGROUND OF THE INVENTION

1. Field of the Invention

The present invention relates to a data relay device and a multiplex communication system.

2. Related Art

In recent years, sophistication of communication networks advances in various fields as computer technology advances. In the field of motor vehicles, the volume of information exchanged between electronic control units (ECUs) which control electrical components installed on a vehicle increases rapidly. Therefore a multiplex communication system is employed for communication among various ECUs in the vehicle so that the number of wire harnesses required for the communication is reduced.

In the multiplex communication system, a network is formed by connecting nodes such as ECUs or the like to a common communication line. The nodes communicate each other by exchanging data frames through the common communication line. In the vehicle, a plurality of networks are formed for efficient data communication among the ECUs. The number of networks is determined according to the required communication speed, and all nodes are appropriately divided into the networks. Communication between two nodes belonging to different networks is performed via a data relay unit.

The data relay unit includes a plurality of send/receive (SR) means corresponding to the respective networks. It receives a data frame via one of the SR means, and sends the data frame via other ones of the SR means (U.S. Pat. No. 5,856,976).

When the multiplex communication system is upgraded, the networks are reconfigured by adding or eliminating the nodes included in each network or modifying the function of the nodes. It is also required to modify data which is included in the data relay unit and used for relaying data frames if data types of data which should be relayed to the nodes are added or eliminated or node IDs of the nodes to which data is relayed are changed as the networks are reconfigured. Further it is required to modify the setting in nodes which is set to send data frames to the node whose ID is changed.

In the field of motor vehicle, vehicle components are highly computerized and control technology therefor is sophisticated. Therefore it consumes much time to reconfigure the multiplex communication system in a vehicle.

### SUMMARY OF THE INVENTION

The present invention overcomes the above drawbacks, and has an object to provide a data relay unit and a multiplex communication system which can be readily reconfigured.

The multiplex communication system according to the present invention includes a data relay unit. The data relay unit includes a plurality of send/receive (SR) means for sending and receiving data frames and a header processing means. Multiplex communication lines are connected to the respective SR means, and nodes which communicate data frames to each other are connected to the communication lines. The data relay unit further includes a destination table and a header table. A data frame which is sent from a node connected to a communication line is received by the SR means connected to the communication line. The received data frame is sent to the destination node by other ones of the SR means as follows. First, the SR means which ought to send the data frame to the destination nodes are identified by referring to the destination table. The header processing means forms a header corresponding to the data type of the received data frame by referring to the header table. The formed header is added to the data body of the received data frame and outputted to the identified SR means. The SR means sends the formed data frame to the destination node through the communication line connected to the SR means.

When the function of some nodes is modified or nodes connected to the communication lines are added or eliminated, the multiplex communication system can be reconfigured only by modifying the content of the destination table and the header table. It is not required to modify the settings in the nodes which is set to sent data frames to the nodes which is modified, or added or eliminated. Thus the multiplex communication system can be reconfigured without consuming much time.

Preferably, the data relay unit includes a plurality of header tables corresponding to different communication protocols. In this case, the data relay unit can relay data received from a node connected to a communication line which employs a communication protocol to a node connected to a communication line which employs another communication protocol.

### BRIEF DESCRIPTION OF THE DRAWINGS

The invention, together with additional objects, features, and advantages thereof, will be best understood from the following description, the appended claims and the accompanying drawings in which:

FIG. 1 is a schematic diagram of a multiplex communication system including a data relay unit according to a first embodiment of the present invention;

FIG. 2 is a functional block diagram of the data relay unit according to the first embodiment of the present invention;

FIGS. 3A-3D show formats of data frames according to BEAN protocol, CAN protocol, ISO9141 protocol, and IE-BUS protocol, respectively;

FIG. 4 shows content of a destination table stored in the data relay unit;

FIGS. 5A and 5B show contents of a BEAN header table and a CAN header table;

FIGS. 6A and 6B are flowcharts of control performed in the data relay unit;

FIG. 7 is a multiplex communication system including a data relay unit according to a second embodiment of the present invention; and

FIG. 8 is the data relay unit according to the second embodiment of the present invention.

### DETAILED DESCRIPTION OF THE PREFERRED EMBODIMENT

The present invention will be described with reference to embodiments and modifications.

(First Embodiment)

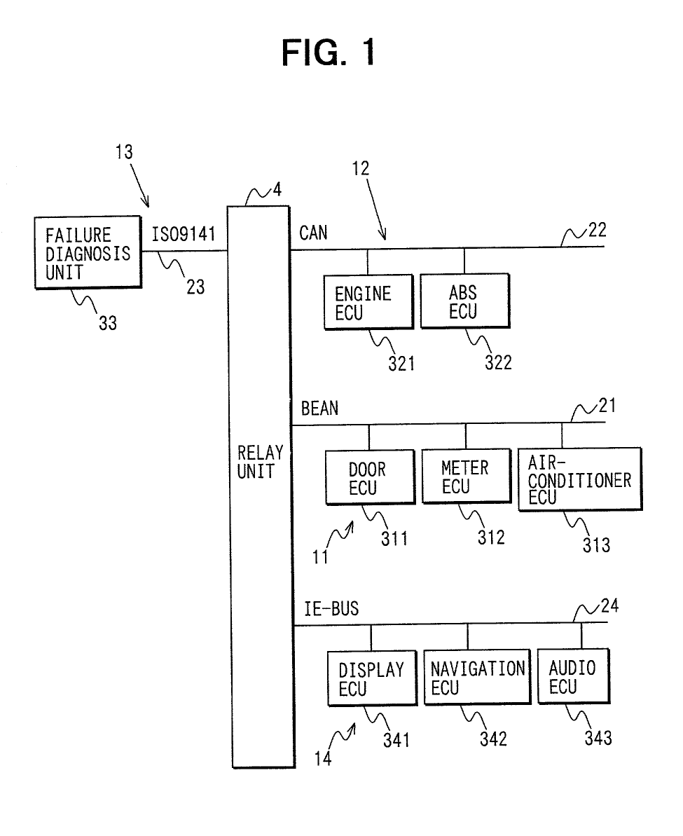

Referring to FIG. 1, a multiplex communication system includes a plurality of networks 11-14 and a data relay unit 4. Each network 11-14 is formed by connecting at least one node (ECU) 311, 312, 313, 321, 322, 33, 341, 342, 343 to a multiplex communication line 21, 22, 23, 24. Data communication between the nodes 321, 322 within the network 22 is performed according to a predetermined communication protocol.

When the multiplex communication system is used for communication among ECUs in a vehicle, the first network 11 includes a door ECU 311, a meter ECU 312, an air-conditioner ECU 313 and the like as nodes. In the first network 11, communication between the nodes is performed according to communication protocol BEAN. The second network 12 includes an engine ECU 321, an ABS ECU 321 and the like as nodes. In the second network 12, communication between the nodes is performed according to communication protocol CAN. The third network 13 includes a failure diagnosis unit 33 as a node, and communication in this network 13 is performed according to communication protocol ISO 9141. The fourth network 14 includes a display ECU 341, a navigation ECU 342, audio ECU 343, and the like as nodes. In the fourth network 14, communication between the nodes is performed according to communication protocol IE-BUS. The display ECU 341 is integrated with control switches for a display. The failure diagnosis unit 33 is connected to the third network 13 when the vehicle is repaired in a repair shop. Failure information or operation information of various parts of the vehicle is sent from the nodes 311, 312, 313, 321, 322, 341, 342, 343 in the other networks 11, 12, 14 to the failure diagnosis unit 33 via the data relay unit 4. The failure diagnosis unit 33 provides the received information for repair of the vehicles.

All the nodes in the multiplex communication system are appropriately divided into the networks according to the required communication speed and the amount of data to be sent. The communication protocol used in each network 11-14 is also determined according to the required communication speed and the amount of data to be sent.

The nodes belonging to the same network communicates each other by exchanging data frames formed according to the communication protocol employed by the network. Each data frame includes not only a data body but also a header including a data type field so that the destination node of the data frame can use the data body. The data types are ‘engine speed’, ‘vehicle speed’, ‘opened/closed state of the doors’ or the like. The destination node receives the data frame, and then determines from the content of the header whether the data body includes data required for the node or what type of data the data body includes.

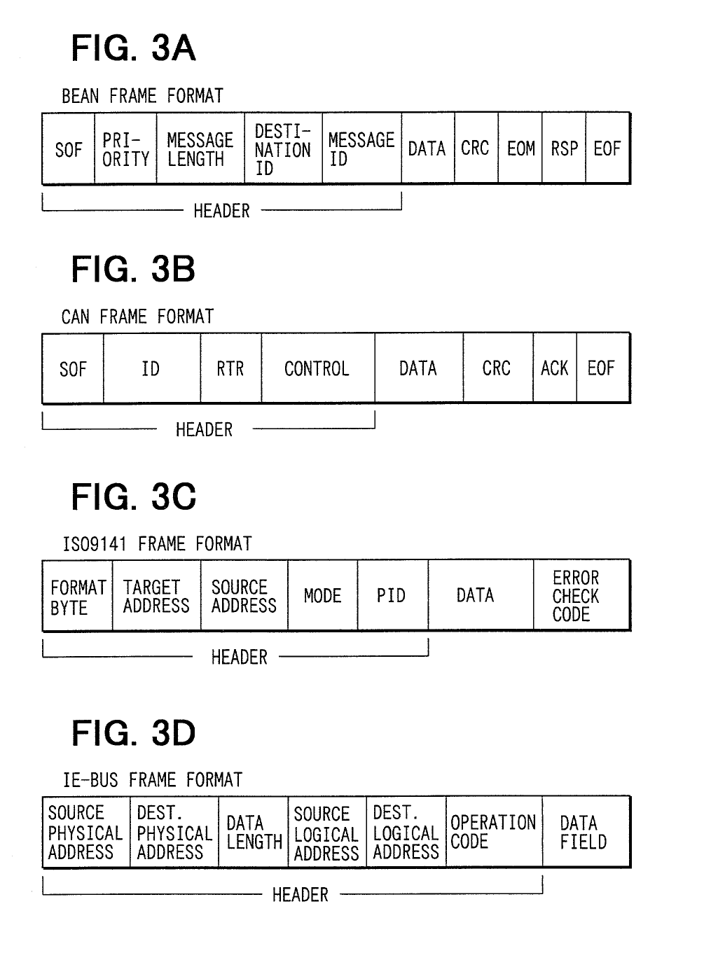

Referring to FIG. 3A, the header of each data frame according to BEAN protocol includes ‘SOF’, ‘Priority’, ‘Message Length’, ‘Destination ID’, and ‘Message ID’. The content of the ‘Destination ID’ field is destination node ID or ‘broadcast’. The content of the ‘Message ID’ field represents the data type of data included in the data body (DATA in FIG. 3A).

Referring to FIG. 3B, the header of each data frame according to CAN protocol includes ‘SOF’, ‘ID’, ‘RTR’, and ‘CONTROL’. The ‘ID’ field includes the data type of data in the data body (DATA), the destination, and the priority.

Referring to FIG. 3C, the header of each data frame according to ISO9141 protocol includes ‘Format Byte’, ‘Target Address’, ‘Source Address’, ‘Mode’, and ‘PID’. The content of the ‘Target Address’ field and the content of the ‘PID’ field cooperatively represent the data type of data included in the data body (DATA).

Referring to FIG. 3D, the header of each data frame according to IE-BUS protocol includes ‘Source Physical Address’, ‘Destination Physical Address’, ‘Data Length’, ‘Source Logical Address’, ‘Destination Logical Address’ and ‘Operation Code’. The content of the ‘Operation Code’ field includes the data type of data in the data body (Data field).

The communication lines 21-24 are connected to the data relay unit 4. The data relay unit 4 is provided to relay data received from a node (source node) 311-343 to another node (destination node) 311-343 belonging to another network 11-14 than the network to which the source node belongs.

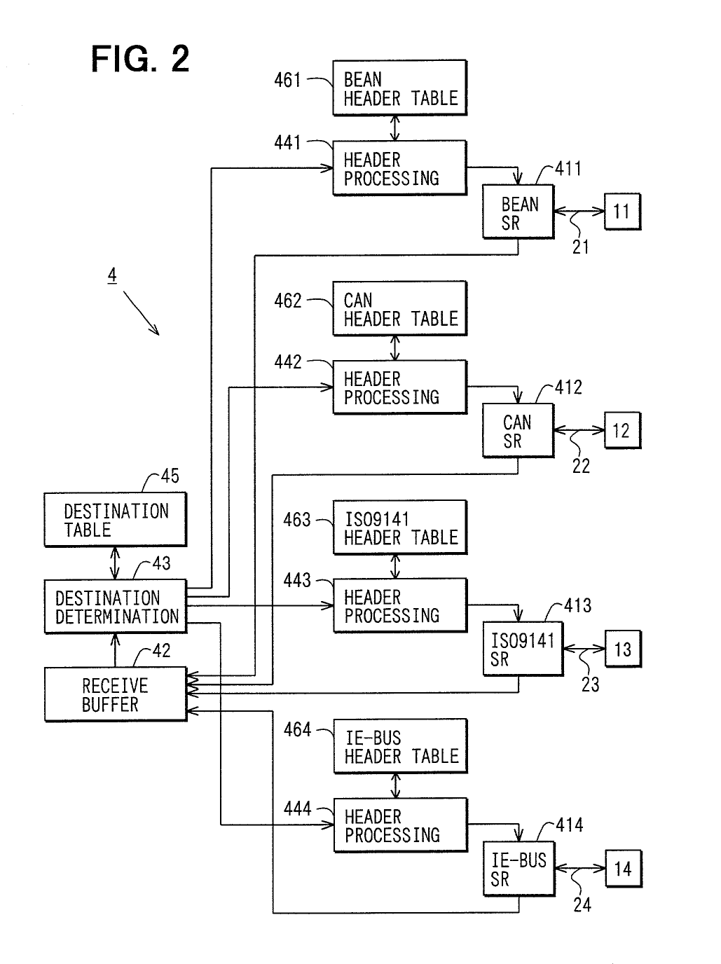

Referring to FIG. 2, the data relay unit 4 includes an IC for communication, a microcomputer for control, and the like. The data relay unit 4 includes four send/receive (SR) sections 411-414 which are SR means for communicating with the nodes in the four networks 11-14, respectively. Therefore the communication line 21 of the first network 11 is connected to the first SR section 411 (BEAN SR section). The communication line 22 of the second network 12 is connected to the second SR section 412 (CAN SR section). The communication line 23 of the third network 13 is connected to the third SR section 413 (ISO9141 SR section). The communication line 24 of the fourth network 14 is connected to the fourth SR section 414 (IE-BUS SR section).

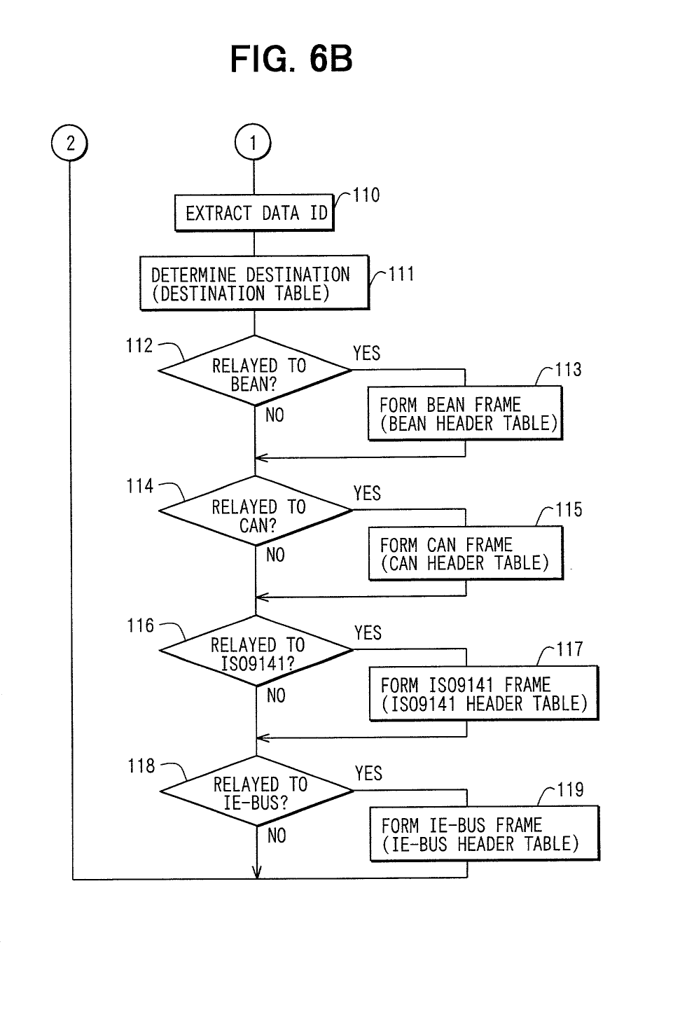

Referring to FIGS. 6A and 6B, if the relay unit 4 determines that a data frame is received by the BEAN SR section 411 at step 101, the received data frame is temporarily stored in a receive frame buffer 42 at step 102. If the data relay unit 4 determines that a data frame is received by the other SR sections 412-414 at steps 103, 105, 107, the received data frame is temporarily stored in the receive frame buffer 42 at steps 104, 106, 108 similarly. The receive frame buffer 42 is provided for each data ID which represents the data type. A predetermined area of a RAM is allocated for the receive frame buffers 42.

If it is determined at step 109 that there is a frame received and stored in the receive frame buffers 42, a destination determination section 42 extracts the data ID from the stored frame at step 110. Further the destination determination section 42 determines the destination networks of the frame at step 111 by referring to a destination table 45 based on the extracted data ID. The destination table 45 is stored in a predetermined area in an EEPROM.

If the destination determination section 42 determines at step 112 that the destination networks of the frame includes BEAN network 11, a BEAN header processing section 441 forms a BEAN header at step 113 by looking up header information in a BEAN header table 461 based on the extracted data ID. Further, at step 113, the BEAN header processing section 441 adds the formed BEAN header to the data body extracted from the data frame stored in the receive frame buffer 42. The combined header and data body is outputted to the BEAN SR section 411. The BEAN SR section 411 adds an overhead portion of the BEAN frame to the combined header and data body. The overhead portion of the BEAN frame includes CRC, EOM and the like. Thus the BEAN data frame is formed, and sent to the destination node in the BEAN network 11 at a time predetermined according to BEAN protocol.

If the destination determination section 42 determines at step 114 that the destination networks of the frame includes the CAN network 12, a CAN header processing section 442 forms a CAN header at step 115 by looking up header information in a CAN header table 462 based on the extracted data ID. Further, at step 115, the CAN header processing section 442 adds the formed CAN header to the data body extracted from the data frame stored in the receive frame buffer 42. The combined header and data body is outputted to the CAN SR section 412. The CAN SR section 412 adds an overhead portion of the CAN frame to the combined header and data body. Thus the CAN data frame is formed, and sent to the destination node in the CAN network 12 at a time predetermined according to CAN protocol.

If the destination determination section 42 determines at step 116 that the destination networks of the frame includes the ISO9141 network 13, an ISO9141 header processing section 443 forms an ISO9141 header at step 116 by looking up header information in an ISO9141 header table 463 based on the extracted data ID. Further, at step 116, the ISO9141 header processing section 443 adds the formed ISO9141 header to the data body extracted from the data frame stored in the receive frame buffer 42. The combined header and data body is outputted to the ISO9141 SR section 413. The ISO9141 SR section 413 adds an overhead portion of the ISO9141 frame to the combined header and data body. Thus the ISO9141 data frame is formed, and sent to the destination node in the ISO9141 network 12 at a time predetermined according to ISO9141 protocol.

If the destination determination section 42 determines at step 118 that the destination networks of the frame includes the IE-BUS network 14, an IE-BUS header processing section 444 forms an IE-BUS header at step 119 by looking up header information in an IE-BUS header table 464 based on the extracted data ID. Further, at step 119, the IE-BUS header processing section 444 adds the formed IE-BUS header to the data body extracted from the data frame stored in the receive frame buffer 42. Thus the IE-BUS data frame is formed, and outputted to the IE-BUS SR section 414. The IE-BUS SR section 414 sends the formed IE-BUS frame to the destination node in the IE-BUS network 14 at a time predetermined according to IE-BUS protocol.

The header tables 461-464 are stored in the same EEPROM which stores the destination table 45, but in another predetermined area than the area in which the destination table 45 is stored.

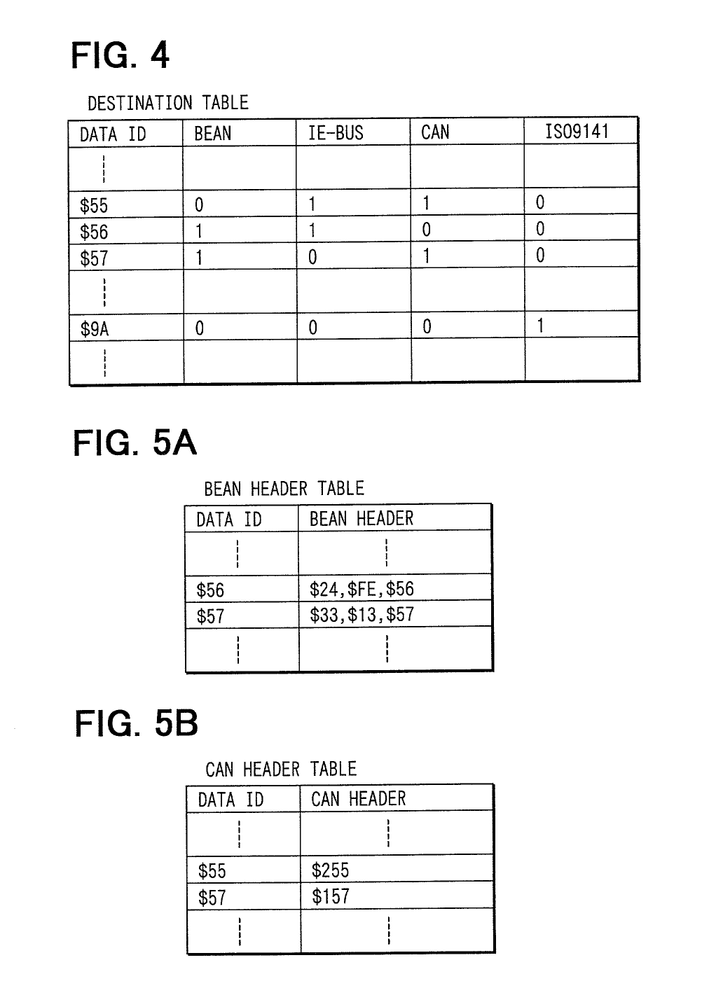

Referring to FIG. 4, the destination table 45 includes four fields (BEAN, IE-BUS, CAN, ISO9141) corresponding to the networks 11-14 for each data ID. Each field holds a value ‘0’ or ‘1’. If the value in a field is ‘0’, it means that a data frame which has the data ID corresponding to the field is not relayed to the network corresponding to the field. If the value in a field is ‘1’, it means that a data frame which has the data ID corresponding to the field is relayed to the network corresponding to the field. Therefore, the destination determination section 43 can determine the destination networks of a data frame by referring to the destination table 45 based on the data ID extracted from the data frame.

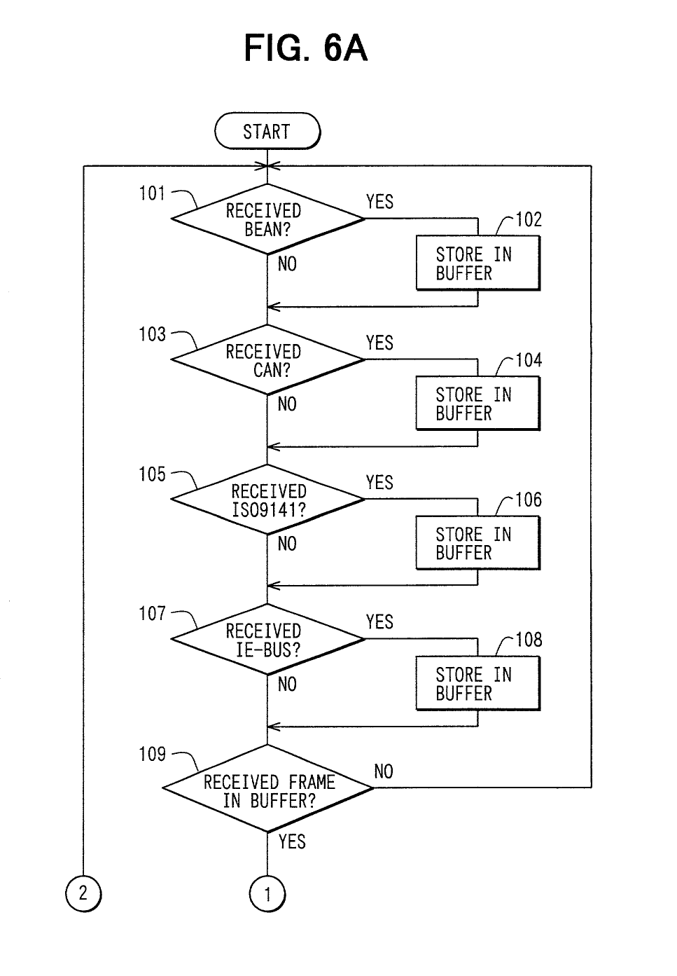

Referring to FIG. 5A, the BEAN header table 461 includes header information for each valid data ID for the BEAN network 11. The valid data ID for the BEAN network 11 means a data ID of data which should be relayed to the BEAN network 11. That is, a data ID is a valid data ID for the BEAN network 11 only if the data ID corresponds to a field which corresponds to the BEAN network 11 and holds a value ‘1’ in the destination table 45. The header information for each valid data ID comprises three portions separated by commas. These three portions corresponds to the fields ‘Priority’, ‘Destination ID’, and ‘Message ID’ of the BEAN frame shown in FIG. 3A, respectively. These fields are substantial portions of the BEAN header. ‘SOF’ is the same irrespective of data ID. ‘Message Length’ can be obtained by adding the length of the data body (DATA) in bytes to 2 bytes of ‘Destination ID’ and ‘Message ID’. Accordingly the BEAN header processing section 411 can appropriately form the BEAN header according to the data ID by using the header information corresponding to the data ID in the BEAN header table 461.

Referring to FIG. 5B, the CAN header table 462 includes header information for each valid data ID for the CAN network 12. This head information corresponds the field ‘ID’ of the CAN frame shown in FIG. 3B. This field is a substantial portion of the CAN header. The CAN header processing section 442 can appropriately form the CAN header according to the data ID by using the header information corresponding to the data ID.

The ISO9141 header table 463 also includes header information corresponding to the substantial portions of the ISO9141 header for each valid data ID for the ISO9141 network 13, so that the ISO9131 header processing portion 443 can appropriately form the ISO9141 header according to the data ID. Similarly, the IE-BUS header table 464 includes header information corresponding to the substantial portions of the IE-BUS header for each valid data ID for the IE-BUS network 14, so that the IE-BUS header processing portion 444 can appropriately form the IE-BUS header according to the data ID.

Next a specific operation of the data relay unit and the multiplex communication system will be explained as an example. When the navigation ECU 342 presumes that a vehicle is approaching a sharp bend, it notifies the engine ECU 321 that it is required to decrease engine torque and direct the meter ECU 312 to show a driver that the vehicle has shifted to a navigation cooperative control mode as follows. The navigation ECU 342 forms an IE-BUS data frame which includes data representing that it is required to decrease the engine torque. In the formed IE-BUS frame, the data ID is set to ‘$57’. The navigation ECU 342 sends the IE-BUS frame over the communication line 24 in the IE-BUS network 14.

The data relay unit 4 receives the IE-BUS frame by the IE-BUS SR section 414 and temporarily stores the received IE-BUS frame in the receive frame buffer 42. Then the destination determination section 43 refers to the destination table 45 shown in FIG. 4. Among the fields corresponding to ‘$57’ in the destination table 45, all the fields holding a value ‘1’ are the field corresponding to ‘BEAN’ and the field corresponding to ‘CAN’. Therefore the data frame stored in the receive frame buffer 42 is outputted to the BEAN header processing section 441 and the CAN header processing section 442.

The BEAN header processing section 441 refers to the BEAN header table 461 shown in FIG. 5A. The header information held in the field corresponding to ‘$57’ in the BEAN header table 461 is ‘$33, $13, $57’. By using this header information, the BEAN header processing section 441 forms a BEAN header. The formed BEAN header is added to the data body extracted from the data frame stored in the receive frame buffer 42, and outputted to the BEAN SR section 411. The BEAN SR section 411 forms a BEAN data frame by adding overhead portion to the received header and data body, and sends the formed BEAN frame over the BEAN network 11.

On the other hand, the CAN header processing section 442 refers to the CAN header table 462 shown in FIG. 5B. The header information held in the field corresponding to ‘$57’ in the CAN header table 462 is ‘$157’. By using this header information, the CAN header processing section 442 forms a CAN header. The formed CAN header is added to the data body extracted from the data frame stored in the receive frame buffer 42, and outputted to the CAN SR section 412. The CAN SR section 412 forms a CAN data frame by adding overhead portion to the received header and data body, and sends the formed CAN frame over the CAN network 12.

The engine ECU 321 receives the BEAN data frame in which the data ID is set to ‘$57’. In response to this, the engine ECU 321 controls the engine to decrease the engine torque. The meter ECU 312 receives the CAN data frame in which the data ID is set to ‘$57’. In response to this, the meter ECU 312 shows on the screen that the vehicle has shifted to the navigation cooperative control mode.

In this multiplex communication system, each network can select an appropriate communication protocol for communication between nodes within the network, because the data relay unit can relay data from a network employing a communication protocol to another network employing another communication protocol.

When the multiplex communication system is reconfigured, the destination table 45 and the header tables 461-464 are updated if the data types of data which should be relayed to the networks are added or eliminated or node IDs of nodes to which data is relayed are changed. The update is achieved only by rewriting the tables 45, 461-464 in the ROM or replacing the ROM.

Changing the content of a field corresponding to a data ID and a network in the destination table 45 from ‘relayed’ to ‘not-relayed’ is essentially equivalent to resetting nodes which is set to send a data frame having the data ID to the nodes in the network so that nodes after resetting does not send a data frame having the data ID to any nodes in the multiplex communication system or to the nodes in the network. Further, changing the content of a field corresponding to a data ID in a header table corresponding to a network is essentially equivalent to resetting nodes which is set to send a data frame which has the data ID to the nodes in the network.

Therefore the multiplex communication system can be reconfigured only by updating the tables 45, 461-464 in the data relay unit 4. It is not required to reset the nodes which is set to send a data frame to a node in which data IDs of data that should be relayed to the node are added or eliminated or node ID of the node are changed. Thus the multiplex communication system is reconfigured without consuming much time.

This embodiment may be applied to other technical fields than the field of a control system in a motor vehicle.

(Second Embodiment)

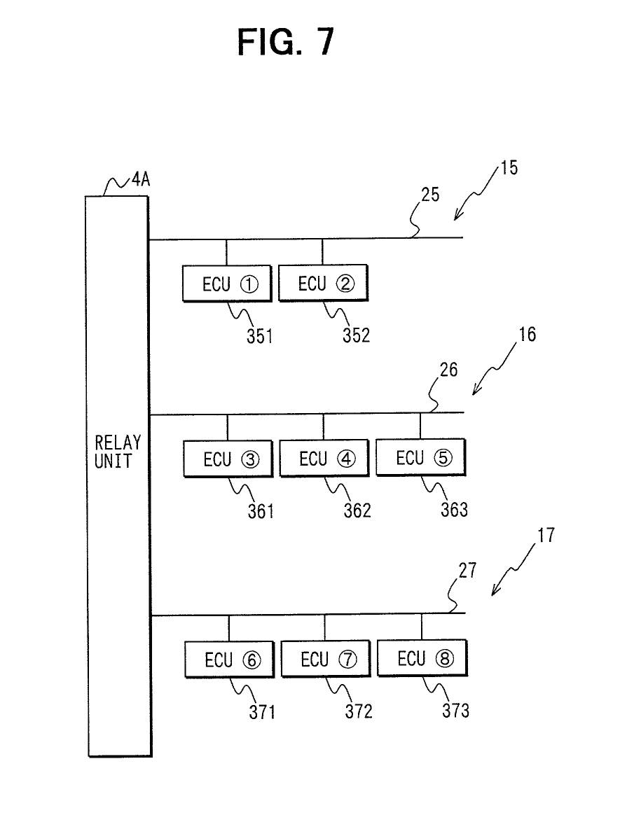

Referring to FIG. 7, a multiplex communication system includes three networks 15, 16, 17. The first network 15 is formed by connecting two ECUs 351, 352 to a communication line 25 as nodes. The second network 16 is formed by connecting three ECUs 361, 362, 363 to a communication line 26 as nodes. The third network 17 is formed by connecting three ECUs 371, 372, 373 to a communication line 27 as nodes. Data sent from a node in a network 15-17 to a node in another network 15-17 is relayed by a data relay unit 4A. All the networks 15-17 employ the same communication protocol.

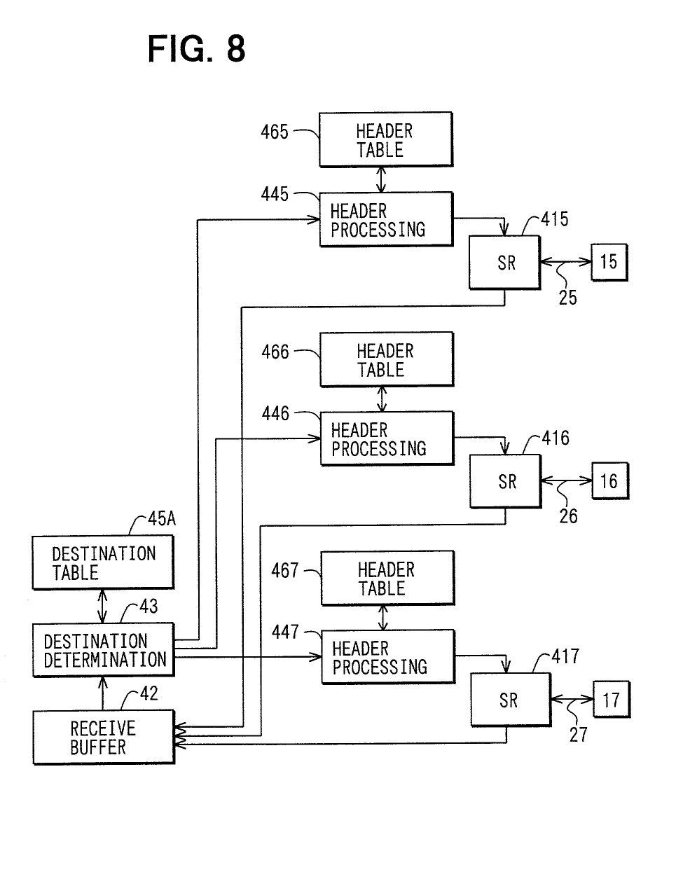

Referring to FIG. 8, the data relay unit 4A includes three SR sections 415-417 connected to the respective networks 15-17. Data frames received by the SR sections 415-417 are temporarily stored in receive frame buffers 42. The destination determination section 43 determines the destination networks of the frame stored in the receive frame buffers 42 by referring to a destination table 45A based on the data ID extracted from the frame. The frame is outputted to the SR sections 415-417 corresponding to the destination networks. Each SR section 415-417 has a corresponding header processing section 445-447. Each of the header processing sections 445-447 corresponding to the destination networks forms a header by looking up header information in a corresponding header table 465-467 similarly to the first embodiment. The formed header includes a portion independent of data ID, and this portion is formed without using the header information in the header table 465-467. The formed header is added to the data body extracted from the frame stored in the receive frame buffer 42 and outputted to the corresponding SR section 415-417. The SR section 415-417 adds an overhead portion to the received header and data body. Thus the data frame according to the communication protocol employed by the destination network is formed, and sent over the communication line 25-27 of the destination network 15-17.

The destination table 45A includes three fields corresponding to the respective networks 15-17 for each data ID. The value in each field represents ‘relayed’ or ‘not relayed’ similarly to the destination table 45 of the first embodiment. Each of the header tables 465-467 includes header information for each valid data ID for the corresponding network similarly to the header tables 461-464 of the first embodiment.

In this embodiment, the multiplex communication system can be reconfigured only by updating the tables 45A, 465-467 in the data relay unit 4A similarly to the first embodiment. Thus time required for reconfiguration of the system is reduced.

(Modifications)

The number of networks included in a multiplex communication system is not limited to 3 or 4. That is, the multiplex communication system according to the present invention may include an arbitrary number of networks.

In the first embodiment, each network in the multiplex communication system need not employ a different communication protocol from all of the communication protocols employed by the other networks. That is, some of the networks in the multiplex communication system may employ the same communication protocol.

The communication protocol employed by each network is not limited to BEAN or the like employed in the first embodiment. That is, each network may employ any communication protocol such as VAN or PALMNET as long as the communication protocol provides the structure of a data frame that includes a header so that the destination node of the frame can use the data body in the frame.

What is claimed is:

1. A data relay unit comprising:
a plurality of send/receive means for sending and receiving data frames each of which is formed by adding a header including a data type which identifies content of a data body to the data body according to a predetermined protocol so that the data body is usable in a predetermined destination, wherein a data frame is received by one of the send/receive means and sent by another one of the send/receive means,
characterized by further comprising:
destination table means for identifying the send/receive means which sends the received data frame based on a data type of the received data frame;
header table means for providing header information based on the data type of the received data frame; and
header processing means for forming a header corresponding to the data type of the received data frame by using the header information received from the header table means and adding the formed header to the data body of the received data frame,
wherein the combined header and data body is outputted to the send/receive means identified by the destination table means.

2. A data relay unit as in claim 1, wherein:
the header table means is provided for each of the send/receive means; and
each of the header tables provides header information according to a communication protocol according to which a corresponding send/receive means sends a data frame.

3. A multiplex communication system comprising:
a data relay unit as in claim 1;
communication lines connected to the respective send/receive means; and
nodes which are connected to the communication lines and send and receive data frames.

4. A data relay unit as in claim 1,
wherein the header processing means is provided for each of the send/receive means.

5. A data relay unit as in claim 1,
wherein each of the identified send/receive means forms a data frame by adding the overhead portion to the combined header and data body received from the header processing means, and sends the formed data frame.

6. A multiplex communication system as in claim 3,
wherein each of the communication lines employs different communication protocol.

7. A multiplex communication system as in claim 3,
wherein some of the communication lines employ the same communication protocol.

8. A multiplex communication system as in claim 3,
wherein all the communication lines employ the same communication protocol.

9. A multiplex communication system as in claim 3,
wherein nodes are ECUs in a vehicle.

10. A method of relaying data in a multiplex communication system having a plurality of networks, each network having at least one electronic control unit, the method comprising the steps of:
receiving a data frame from a first one of the networks, the data frame being formed with a data body and a header that includes a data type therein;
determining a second one of the network to which the received data frame is sent by referring to a destination table stored in a memory, the destination table defining a predetermined relation between data types of receive data and networks to which received data frames are sent;
adding a header information to a data body of the received data frame by referring to a header table stored in the memory, the header table defining header information which are added in correspondence with the data types of receive data frame, respectively; and
sending the combined data body and the header information to the second network.

12. A method of relaying data as in claim 11, wherein:
the first network and the second network are operable under different communication protocols from each other;
the destination table defines the second network by way of communication protocols; and
the header table defines the header information in correspondence with the communication protocols.

13. A method of relaying data as in claim 11, wherein:
the networks are provided in a vehicle; and
the memory is provided separately from the electronic control unit of each network.
